(19) United States
(12) Patent Application Publication
(10) Pub. No.: US 2010/0139384 A1
(43) Pub. Date: Jun. 10, 2010

(54) CURRENT TANK SYSTEMS AND METHODS

(76) Inventors: Donald Wayne Allen, Richmond, TX (US); Dean Leroy Henning, Needville, TX (US); David Wayne McMillian, Deer Park, TX (US); Janet Kay McMillian, Deer Park, TX (US); Raghunath Gopal Menon, Katy, TX (US); Ernesto Uehara-Nagamine, Houston, TX (US); Christopher Steven West, Pearland, TX (US)

Correspondence Address: SHELL OIL COMPANY, P O BOX 2463, HOUSTON, TX, 772522463, US

(21) Appl. No.: 12/278,673

(22) PCT Filed: Feb. 8, 2007
(86) PCT No.: PCT/US07/61850

§ 371 Date: Sep. 9, 2009

Related U.S. Application Data
(60) Provisional application No. 60/771,647, filed on Feb. 9, 2006.

(51) Int. Cl. G01M 9/02

(52) U.S. Cl. 73/147

(57) ABSTRACT

There is disclosed a current tank system comprising a first current tank adapted to produce a first current in a first direction, and a second current tank adapted to produce a second current in a second direction. There is also disclosed a method of testing a sample, comprising exposing the sample to a first current in a first current tank, and exposing the sample to a second current in a second current tank.

### FIELD OF THE INVENTION

This application relates to current tanks which may be used to expose a sample to a flowing fluid.

### BACKGROUND

Current tanks and wind tunnels have been used to test the effects of a flowing fluid on a test apparatus.

U.S. Pat. No. 5,866,813 discloses a transportable three-dimensional calibration wind tunnel system which is comprised of a small wind tunnel portion for creating a three-dimensional calibration air having a suitable wind velocity, and a two-axis rotational deformation device portion for causing said wind tunnel portion to effect a conical motion with a nozzle blow port being an apex to suitably change a flow angle. The two-axis rotational deformation device is comprised of a B-angle rotational deformation device having a B-angle deformation base supported to be rotated horizontally, and an A-angle rotational deformation device having an A-angle deformation base supported to be rotated vertically. A rotational axis of the A-angle deformation base, a rotational axis of the B-angle deformation base and a center axis of the small wind tunnel portion are arranged so that they intersect at a point. In a method for the verification of a flight control system of an aircraft using the transportable three-dimensional calibration wind tunnel system, the nozzle blow port of the three-dimensional calibration wind tunnel system is positioned at the extreme end of an air data sensor probe provided on the aircraft, and the three-dimensional calibration wind tunnel system and an on-board control computer of the aircraft are connected to an out-board control computer so that a suitable three-dimensional airflow is generated by the three-dimensional calibration wind tunnel system to verify the operation and function of the control surface in the stopped state on the ground.

Co-pending patent application 60/782,209, has attorney docket number TH3009, was filed Mar. 14, 2006, and discloses a current tank system comprising a first current tank adapted to produce a first current in a first direction; a second current tank adapted to rotate to produce a second current in a second direction; a sample adapted to be exposed to the first current and the second current. Patent application 60/782,209 is herein incorporated by reference in its entirety.

Current tanks and wind tunnels have the limitation that they are not able to create multi-dimensional flow as would be encountered if an apparatus were subjected to multi-dimensional air currents and/or water currents. There is a need in the art to simulate multi-dimensional flow.

### SUMMARY OF THE INVENTION

One aspect of the invention provides a current tank system comprising a first current tank adapted to produce a first current in a first direction, and a second current tank adapted to produce a second current in a second direction.

Another aspect of the invention provides a method of testing a sample, comprising exposing the sample to a first current in a first current tank, and exposing the sample to a second current in a second current tank.

Advantages of the invention include one or more of the following:
exposing a sample to multi-directional current;
modeling a real world multi-directional current in a current tank;
exposing a sample to multi-directional currents with different fluids; and/or
exposing a sample to multi-directional currents with changing directions of the currents.

### BRIEF DESCRIPTION OF THE DRAWINGS

FIG. 1 illustrates a top view of a current tank system.

FIG. 2 illustrates a side view of a current tank system.

FIG. 3 illustrates a top view of a current tank system.

FIG. 4 illustrates a side view of a current tank system.

FIG. 5 illustrates a top view of a current tank.

FIGS. 6a and 6b illustrate current profiles which may be generated by a current tank.

FIG. 7 illustrates a top view of a current tank.

### DETAILED DESCRIPTION

In one embodiment, there is disclosed a current tank system comprising a first current tank adapted to produce a first current in a first direction, and a second current tank adapted to produce a second current in a second direction. In some embodiments, the second current tank is mounted above the first current tank. In some embodiments, one or more of the first and second current tanks are provided with a sealed cover to prevent a fluid from flowing from one of the current tanks to the other. In some embodiments, the first direction and the second direction are separated by an angle from 30 to 180 degrees. In some embodiments, the first direction and the second direction are separated by an angle from 60 to 120 degrees. In some embodiments, the system also includes a test sample exposed to the first current and the second current. In some embodiments, the first current tank further comprises one or more propellers. In some embodiments, the second current tank further comprises one or more thrusters. In some embodiments, the system also includes one or more shear screens, straighteners, and/or turbulence reduction screens. In some embodiments, the second current tank is adapted to be rotated relative to the first current tank. In some embodiments, the system also includes a fluid selected from water, air, brine, and other water based mixtures.

In one embodiment, there is disclosed a method of testing a sample, comprising exposing the sample to a first current in a first current tank, and exposing the sample to a second current in a second current tank. In some embodiments, the first current and the second current are separated by an angle from 30 to 180 degrees. In some embodiments, the first current and the second current are separated by an angle from 60 to 120 degrees.

In some embodiments, the method also includes producing the first current with one or more propellers. In some embodiments, the method also includes producing the second current with one or more thrusters. In some embodiments, the method also includes rotating the second current tank relative to the first current tank, in order to change the direction of the second current relative to the first current. In some embodiments, the second current comprises a current profile of increasing velocity from top to bottom. In some embodiments, the second current comprises a current profile resembling a sine wave from top to bottom. In some embodiments, the method also includes exposing the sample to a third current in a third current tank. In some embodiments, the method also includes measuring a response of the sample to the currents.

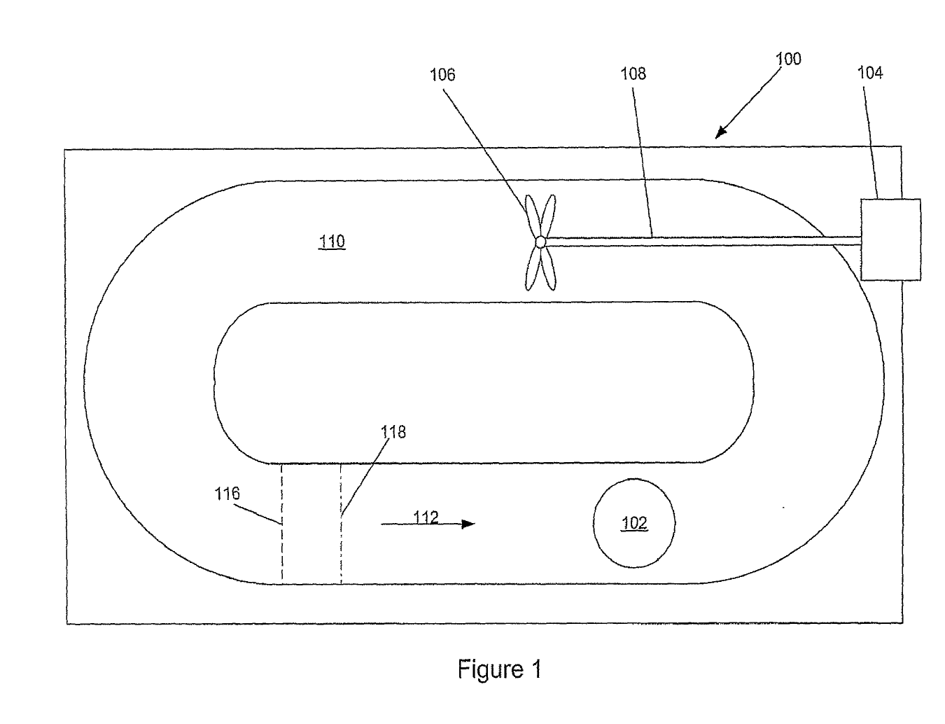

Referring now to FIG. 1, in one embodiment of the invention, there is illustrated a top view of system 100. System 100 includes current tank 110 with current 112. Current 112 is driven with propeller 106 mounted to drive shaft 108 rotated by propulsion system 104, for example, an engine or a motor. Test sample 102 is placed in tank 110 and subjected to current 112.

In some embodiments, shear screen 116 and/or straightener 118 may be provided. In some embodiments, various forms of measurement devices and/or instrumentation may be provided to measure the effects of current 112 on test sample 102. In some embodiments, propeller 106, drive shaft 108, and propulsion system 104 may be replaced with a turbine, a paddle wheel, a fan blade, or other fluid conveying devices as are known in the art.

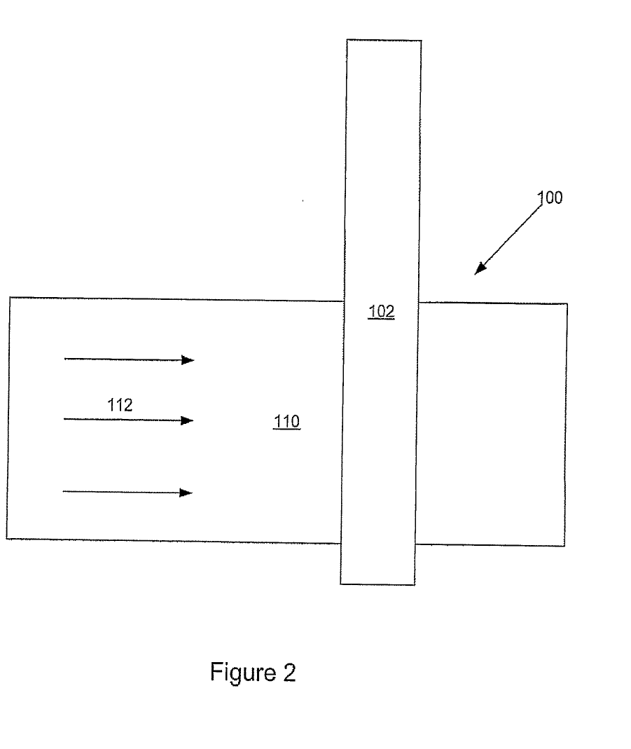

Referring now to FIG. 2, in some embodiments, a side view of system 100 is shown where test sample 102 is shown in current tank 110 subjected to current 112.

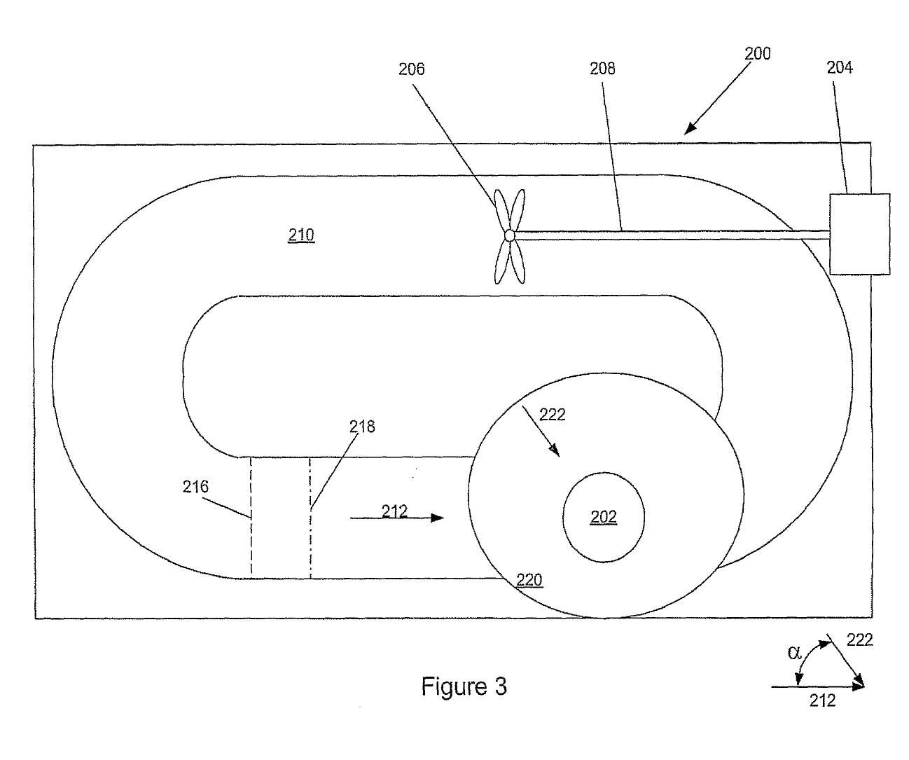

Referring now to FIG. 3, in some embodiments, system 200 is shown. System 200 includes current tank 210 with current 212, and current tank 220 with current 222. Sample 202 is placed in both current tank 210 and current tank 220. System 200 includes current tank 210 with propeller 206 mounted on shaft 208, which may be rotated by propulsion system 204. Shear screen 216 and/or straightener 218 may be provided in current tank 210. Current tank 220 includes a propulsion system (not shown) to create current 222.

In some embodiments, one or more of current tank 210 and/or current tank 220 may be provided with a sealed cover so that the fluid from current tank 220 does not flow into current tank 210 due to gravity. In some embodiments, current tank 210 may be placed on top of current tank 220. In other embodiments, current tank 220 may be placed on top of current tank 210. In some embodiments, current 212 may be offset from current 222 by an angle a from about +/−30 to about +/−180 degrees, for example from about +/−60 to about +/−120 degrees. In some embodiments, straightener 218 may be a turbulence reduction screen.

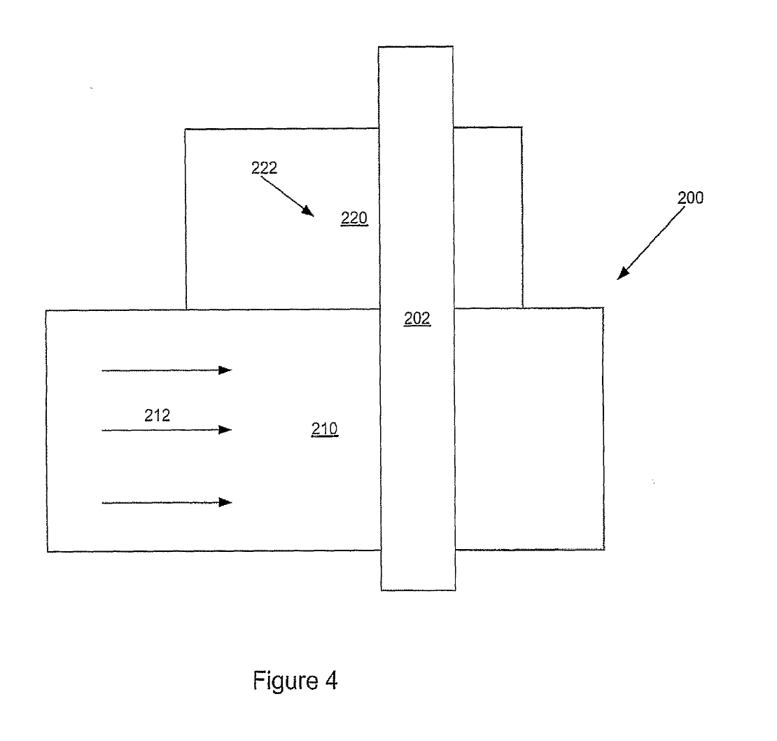

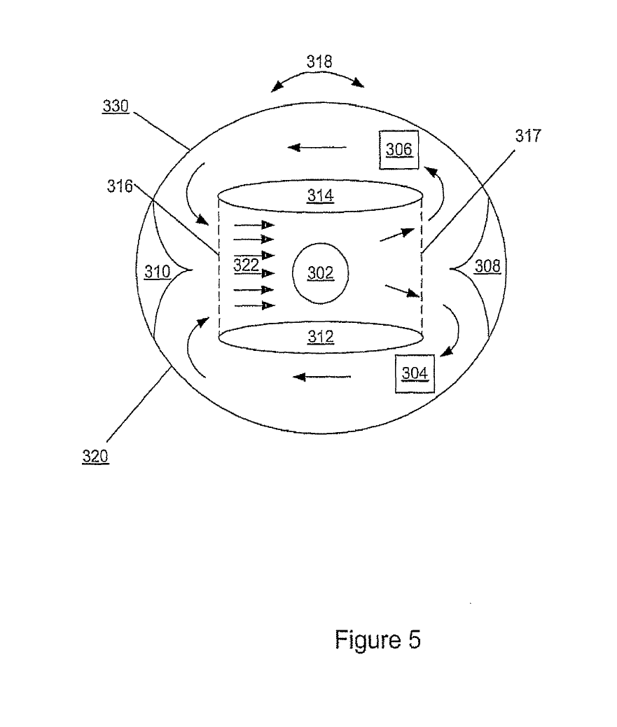

Referring now to FIG. 4, in some embodiments, a side view of current tank 220 mounted on top of current tank 210. Current tank 210 has current 212, and current tank 220 has current 222. Sample 202 is placed in both current tank 210 and current 220 and subjected to both current 212 and current 222. Referring now to FIG. 5, in some embodiments, current tank 320 is illustrated.

Sample 302 has been placed in cylinder 330. Current 322 is created in cylinder 330 by thrusters 304 and 306. One or more conical baffles 308 and/or 310 may be provided in cylinder 330 to help direct the flow 322. Spacers 312 and 314 may be provided to separate flow 322 portions near the test sample 302 from the portions near the thrusters 304 and 306. A primary screen 316, for example a shear and/or a turbulence reduction screen may be provided. A secondary screen 317, for example a shear and/or a turbulence reduction screen may be provided.

In some embodiments, current tank 320 (including cylinder 330, baffles 308 and 310, thrusters 304 and 306, and spacers 312 and 314) may be rotated clockwise or counter-clockwise as shown by arrows 318, in order to change the direction of flow 322 relative to sample 302. In some embodiments, baffles 308 and 310, thrusters 304 and 306, and spacers 312 and 314 may be rotated clockwise or counter-clockwise as shown by arrows 318 within cylinder 330, in order to change the direction of flow 322 relative to sample 302.

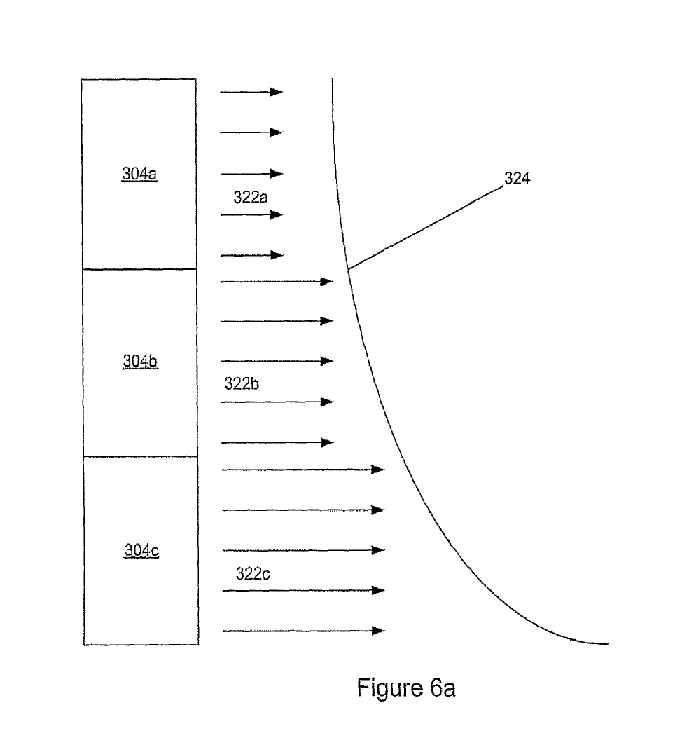

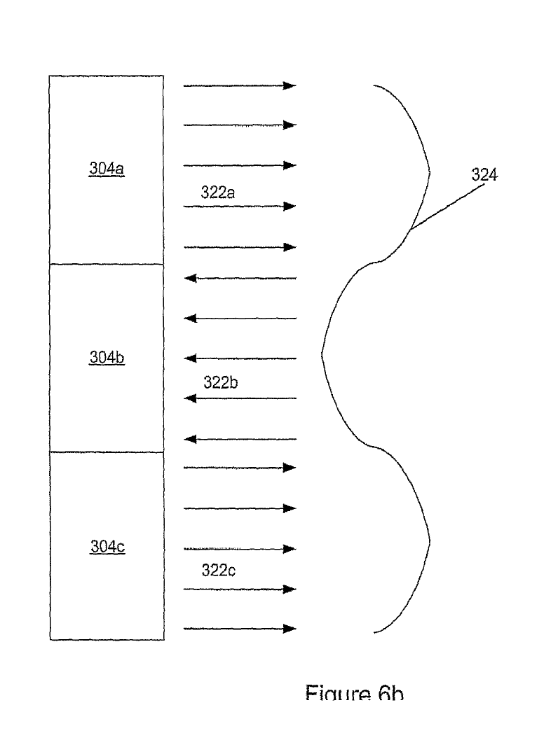

Referring now to FIG. 6a, in some embodiments, a side view of thruster 304 is shown, which includes top section 304a, middle section 304b, and bottom section 304c. Top section 304a produces current 322a, middle section 304b produces middle current 322b, and bottom section 304c produces bottom current 322c. The combined effects of the currents 322a, 322b, and 322c produce overall current profile 324. In some embodiments, each of top section 304a, middle section 304b, and bottom section 304c include a current producing device, for example one or more thrusters or propellers.

Referring now to FIG. 6b, in some embodiments, a side view of thruster 304 is shown. Top section 304a produces current 322a, middle section 304b produces current 322b, and bottom section 304c produces bottom current 322c. The combined effects of the currents 322a, 322b, and 322c produce overall current profile 324.

In some embodiments, top current 322a, middle current 322b, and bottom current 322c may be substantially equal. In some embodiments, each of top section 304a, middle section 304b, and bottom section 304c include a current producing device, for example one or more thrusters or propellers. In some embodiments, thrusters 304 and/or 306 may be propellers, turbines, fans, or other fluid moving devices as are known in the art.

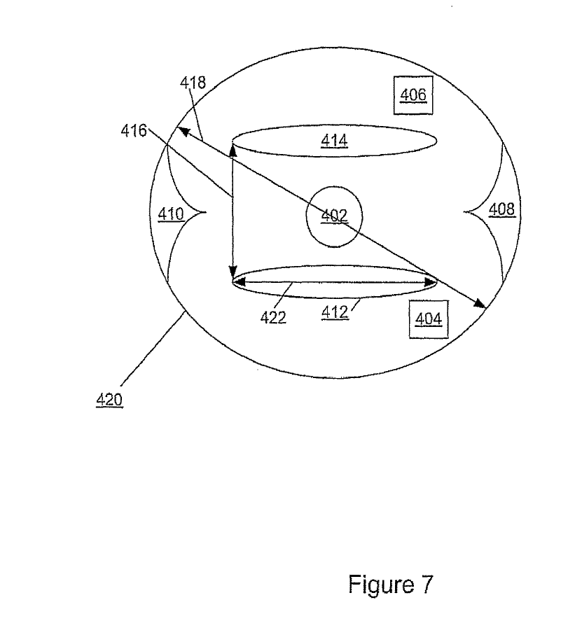

Referring now to FIG. 7, in some embodiments, current tank 420 is illustrated. Current tank 420 includes thrusters 404 and 406, which create a current to which test sample 402 is subjected. Current is directed by conical baffles 408 and/or 410, and spacers 412 and 414. Spacer 412 and/or spacer 414 have a spacer length 422. Current tank 420 has a tank diameter 418. Test sample channel has a channel width 416. Current tank 420 has a height (not shown).

In some embodiments, spacer length 422 is from about 0.5 to about 3 meters, for example about 1 meter. In some embodiments, channel width 416 is from about 0.5 to about 2 meters, for example about 0.75 meters. In some embodiments, tank diameter 418 is from about 1 meter to about 5 meters, for example about 2 meters. In some embodiments, tank height is from about 1 meter to about 10 meters, for example about 2 1/2 meters.

In some embodiments, current tank 220 may be replaced with current tank 320 or current tank 420.

In some embodiments, current tank 210 and/or current tank 220 contain a fluid selected from water, air, and brine or other water based mixtures.

Those of skill in the art will appreciate that many modifications and variations are possible in terms of the disclosed embodiments, configurations, materials and methods without departing from their spirit and scope. Accordingly, the scope of the claims appended hereafter and their functional equivalents should not be limited by particular embodiments described and illustrated herein, as these are merely exemplary in nature.

1. A current tank system comprising:
a first current tank adapted to produce a first current in a first direction;
a second current tank adapted to produce a second current in a second direction;
a sample adapted to be exposed to the first current and the second current.

2. The system of claim 1, wherein the second current tank is mounted above the first current tank.

3. The system of claim 1, wherein one or more of the first and second current tanks are provided with a sealed cover to prevent a fluid from flowing from one of the current tanks to the other.

4. The system of claim 1, wherein the first direction and the second direction are separated by an angle from 30 to 180 degrees.

5. The system of claim 1, wherein the first direction and the second direction are separated by an angle from 60 to 120 degrees.

6. The system of claim 1, further comprising a test sample exposed to the first current and the second current.

7. The system of claim 1, wherein the first current tank further comprises one or more propellers.

8. The system of claim 1, wherein the second current tank further comprises one or more thrusters.

9. The system of claim 1, further comprising one or more shear screens, straighteners, and/or turbulence reduction screens.

10. The system of claim 1, wherein the second current tank is adapted to be rotated relative to the first current tank.

11. The system of claim 1, further comprising a fluid selected from the group consisting of water, air, brine, and other water based mixtures.

12. A method of testing a sample, comprising:
exposing the sample to a first current in a first current tank; and
exposing the sample to a second current in a second current tank.

13. The method of claim 12, wherein the first current and the second current are separated by an angle from 30 to 180 degrees.

14. The method of claim 12, wherein the first current and the second current are separated by an angle from 60 to 120 degrees.

15. The method of claim 12, further comprising producing the first current with one or more propellers.

16. The method of claim 12, further comprising producing the second current with one or more thrusters.

17. The method of claim 12, further comprising rotating the second current tank relative to the first current tank, in order to change the direction of the second current relative to the first current.

18. The method of claim 12, wherein the second current comprises a current profile of increasing velocity from top to bottom.

19. The method of claim 12, wherein the second current comprises a current profile resembling a sine wave from top to bottom.

20. The method of claim 12, further comprising exposing the sample to a third current in a third current tank.

21. The method of claim 12, further comprising measuring a response of the sample to the currents.
